(19) United States
(12) Patent Application Publication
(10) Pub. No.: US 2023/0019729 A1
(43) Pub. Date: Jan. 19, 2023

(54) System and Method of Providing Physically Authenticated Digital Tracking and Association for Objects and Products

(71) Applicants: Alexander James Karp, Escondido, CA (US); Gregory Frank Matula, Escondido, CA (US)

(72) Inventors: Alexander James Karp, Escondido, CA (US); Gregory Frank Matula, Escondido, CA (US)

(21) Appl. No.: 17/936,437

(22) Filed: Sep. 29, 2022

Related U.S. Application Data
(63) Continuation-in-part of application No. 16/875,567, filed on May 15, 2020, now abandoned.

(51) Int. Cl. G06Q 30/00; H04L 9/00; H04L 9/08

(52) U.S. Cl. CPC G06Q 30/0185; H04L 9/50; H04L 9/0836

(57) ABSTRACT

A method and system comprising; a physical medium having a first unique identifier and a second unique identifier stored within; where said physical medium is in communication with a first distributed ledger having said first unique identifier associated with said second unique identifier stored within; where said distributed ledger is operatively connected with a first comparison algorithm providing; physical authentication of data associated with additional data elements; further provides mathematical coupling to further additional data which allows for novel visibility and management, including reducing inefficiencies and errors, within physical systems, for example product supply chains, without the need to fully replace current supply chain management systems.

### CROSS-REFERENCE TO RELATED APPLICATIONS

This application claims benefit under 35 U.S.C. § 119 to U.S. Provisional Application Ser. No. 62/858,885, entitled “System for Physically Authenticated Digital Tracking”, filed on Jun. 7, 2019, the contents of which are herein incorporated by reference under 37 CFR 1.57(b).

This application claims benefit to the earlier filing date and right of priority under 35 U.S.C. § 120 to U.S. patent application Ser. No. 16/875,567, entitled “SYSTEM AND METHOD PROVIDING PHYSICALLY AUTHENTICATED DIGITAL TRACKING AND ASSOCIATION”, the contents of which are herein incorporated by reference under 37 CFR 1.57(b).

### BACKGROUND OF THE INVENTION

### Technical Field

The present invention relates generally to systems and methods of providing physically authenticated digital tracking and association for manufactured objects and the raw materials associated therewith for the purpose of providing a representative value of trust for a transaction record linked to said manufactured objects and said raw materials associated therewith to enable and/or enhance tracking and verification of authenticity (chain of custody) of said manufactured objects and said raw materials associated therewith.

The present invention relates generally to a physical authentication trust factor system whose purpose is to create a representative value of trust for a transaction record that is associated with and/or linked uniquely to an object such as a manufactured object and/or the raw materials associated therewith to enable and/or enhance tracking and verification of authenticity (chain of custody) of said manufactured objects and said raw materials associated therewith.

The present invention relates generally to a method of providing a representative value of trust for an object such as a manufactured object and/or the raw materials associated therewith comprising a plurality of evaluation indices and comparisons to enable creation of levels or layers of trustability for the data elements used to track objects and verify their authenticity and/or chain of custody.

### Background Art

It is well known that it is advantageous to track physical products (objects) throughout the product lifecycle from idea generation through end-consumer use until disposal. Current attempts to provide information about physical attributes of these products use a complex system of individual and batch product identifiers, human readable and/or machine-readable markings, databases, ledgers, and record books.

Often these transaction/tracking records are maintained in separate systems across various physical and digital locations, and further across various organizations and companies. The separated record systems within the art provide limited services with various inefficiencies and challenges. For example, products are often tracked through groupings, such as batches or lots, which results in incomplete records about individual products. In addition to records being incomplete, said records are often duplicated which can lead to conflicting information, data loss, and resources expended on audits.

Additionally, inconsistencies in data records of physical goods (objects) allows for falsified data such as counterfeit products, and prevents traceability which hampers recall notifications, and limits chain of custody verification.

Current approaches to solve these problems generally rely on fully integrated new systems or may rely on replacing non-authenticated data. These attempted solutions require costly integration into multiple proprietary systems, and limits operational expansion into newer technologies and publicly available data elements.

In light of the foregoing prior art, there is a need for better systems and methods of providing physically authenticated digital tracking and association for manufactured objects and the raw materials associated therewith to better enable and/or enhance tracking and verification of authenticity (chain of custody) of said manufactured objects and said raw materials associated therewith by resolving the inconsistencies in data records (transactions) for physical goods (objects), and the resulting potential transaction/date falsification issues present in the prior art.

Further, there is a need for better systems and methods of providing physically authenticated digital tracking and association for manufactured objects and the raw materials associated therewith to better enable and/or enhance tracking and verification of authenticity (chain of custody) of said manufactured objects and said raw materials associated therewith by providing an always present authentication for a transaction thus inhibiting and/or preventing falsification issues present in the prior art.

### BRIEF SUMMARY OF THE INVENTION

The present invention most generally is a system having a method of providing physically authenticated digital tracking in the form of a physical authentication trust factor system used to create a representative value of trust for a transaction record that is associated/linked with an object to enable and/or enhance tracking and verification of authenticity (chain of custody) for any uniquely identified object or constituent component thereof.

According to the present invention, there is a system having a method of providing physically authenticated digital tracking in the form of a physical authentication trust factor system used to create a representative value of trust for a transaction record that is associated/linked with an object to enable and/or enhance tracking and verification of authenticity (chain of custody) for any uniquely identified object or constituent component thereof.

According to a first aspect of the invention there is a physical authentication trust factor system to create a representative value of trust (RVT) for a transaction record (TR) comprising a plurality of unique electronic tracking identifiers (UETI) each comprising a first unique identifier (FUI) linked to an object wherein said FUI comprises a plurality of FUI data elements one of said plurality of FUI data elements comprising an automatically unique identifier, a plurality of evaluation indices (EI's), said plurality of EI's comprising any combination of a weighting criteria, a pattern, a range, a quantity, and/or a value for at least one of a device ID, a device description, a transaction ID, a date/time stamp, a type of transaction, a location data, a UETI, a FUI, and/or a transaction event, an algorithm, a transaction input device, a database comprising said plurality of EI's, and a plurality of historical transactional events (HTE's) said plurality of HTE's comprising said FUI, said UETI, and any combination of a device ID, a device description, a transaction ID, a date/time stamp, a type of transaction, a location data, a UETI, a FUI, and/or a transaction event, a processor, and a user device, wherein said transaction input device collects a plurality of actual transactional events (ATE's) wherein said plurality of ATE's comprises said FUI and any combination of a first physical attribute of said object, said device ID, said device description, said transaction ID, said FUI, said UETI, said date/time stamp, said type of transaction, and said location data, and said plurality of ATE's is transmitted to said database in the form of non-transitory computer-readable media, wherein said processor uses said algorithm for a comparison of each of said ATE's to said plurality of EI's and said plurality of HTE's to determine an RVT for said TR.

According to a second aspect of the invention there is a physical authentication trust factor system further comprising a user uses said user device to access said system and query for a report of said RVT by entering any of said UETI or said FUI. And, further, optionally wherein said ATE's and said HTE's further comprise a user data entered by said user for inclusion in said comparison step contributing to said determination of said RVT for said TR.

According to a third aspect of the invention there is a physical authentication trust factor system wherein said UETI further comprises a second unique identifier (SUI) associated with said object, and after transmission of said ATE's by said transaction input device when no UETI is linked with said SUI, said processor uses said algorithm to link said SUI to said UETI having said FUI associated with said object. And, further, optionally wherein said SUI further comprises an inductive coupling device.

According to a fourth aspect of the invention there is a physical authentication trust factor system wherein said RVT is adjusted according to a plurality of trust valuations, one of said plurality of trust valuations being an increased value for said RVT when a second unique identifier (SUI) is associated with said object and linked to said FUI within said UETI for said object.

According to a fifth aspect of the invention there is a physical authentication trust factor system wherein said processor uses said algorithm for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event, then when there exists an EI that matches at least one of said device ID, said device description, said transaction ID, said FUI, said date/time stamp, said type of transaction, said location data, said UETI, and/or said transaction event, then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT. And, optionally further, wherein adjustment of said RVT is according to a plurality of trust valuations, one of said plurality of trust valuations being an increased value for said RVT when any of said device ID, said device description, said transaction ID, said FUI, said date/time stamp, said type of transaction, said location data, said UETI, and said transaction event include a second unique identifier (SUI) associated with said object and linked to said FUI within said UETI for said object.

According to a sixth aspect of the invention there is a physical authentication trust factor system wherein said transaction input device comprises a cryptographic encoding sequence prior to a reading and/or viewing by a user of said SUI.

According to a seventh aspect of the invention there is a physical authentication trust factor system wherein said database further comprises operational connectivity with a distributed ledger for storing up to all of said plurality of EI's, and said plurality of HTE's.

According to an eighth aspect of the invention there is a physical authentication trust factor system wherein said database further comprises operational connectivity with a blockchain record for storing up to all of said plurality of EI's, and said plurality of HTE's.

According to a ninth aspect of the invention there is a physical authentication trust factor system wherein said database further comprises operational connectivity with a hashgraph record for storing up to all of said plurality of EI's, and said plurality of HTE's.

According to a tenth aspect of the invention there is a physical authentication trust factor system wherein said FUI and said SUI are a-fixed connectively to said object in the form of a device optionally having a physical media having storage for storing any combination of elements from said database. And, further, optionally, comprising a consent cloud in the form of a system that compares a plurality of a change, an update, and/or a request for verification of any of said plurality of EI's, and said plurality of HTE's, and/or said RVT to enable able said change, said update, and/or said request.

According to an eleventh aspect of the invention there is a method of providing a representative value of trust (RVT) for an object comprising: a) reading a at least one transaction record (TR) having at least one unique electronic tracking identifiers (UETI) each comprising a first unique identifier (FUI) linked to said object, said FUI having a plurality of FUI data elements said plurality of FUI data elements comprising an automatically unique identifier, and a first physical attribute of said object, b) reading a plurality of evaluation indices (EI's), said plurality of EI's comprising any of a weighting criteria, a pattern, a range, and/or a value for at least one of a device ID, a device description, a transaction ID, a date/time stamp, a type of transaction, a location data, said UETI, said FUI, and/or a transaction event, c) reading a plurality of historical transactional events (HTE's) said plurality of HTE's comprising said device ID, said device description, said transaction ID, said FUI, said UETI, said date/time stamp, said type of transaction, and said location data, and d) comparing each of said TR's to said plurality of EI's and said plurality of HTE's to determine a RVT for said TR.

According to a twelfth aspect of the invention, there is a method of providing an RVT for an object wherein said UETI further comprises a second unique identifier (SUI) associated with said object, and when no UETI is linked with said SUI linking said SUI to said FUI associated with said object within said UETI. And, optionally wherein reading said SUI further comprises an inductive coupling device.

According to a thirteenth aspect of the invention, there is a method of providing an RVT for an object wherein said RVT is adjusted according to a plurality of trust valuations, one of said plurality of trust valuations being an increased value for said RVT when a second unique identifier (SUI) is associated with said object and linked to said FUI within said UETI.

According to a fourteenth aspect of the invention, there is a method of providing an RVT for an object wherein said ATE's and said HTE's further comprise a user data entered by said user for inclusion in said comparison step contributing to said determination of said RVT for said TR.

According to a fifteenth aspect of the invention, there is a method of providing an RVT for an object wherein for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event when there exists an EI that matches at least one of said device ID, said device description, said transaction ID, said FUI, said date/time stamp, said type of transaction, said location data, said UETI, and/or said transaction event then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT. And, optionally wherein said adjustment to said RVT is according to a plurality of trust valuations one of said plurality of trust valuations being an increased value for said RVT when a second unique identifier (SUI) is associated with said object and linked to said FUI within said UETI.

According to a sixteenth aspect of the invention, there is a method of providing an RVT for an object wherein reading of said TR, EI's, and/or HTE's is reading from a distributed ledger storing up to all of said RVT, TR, EI's, and/or HTE's.

According to a seventeenth aspect of the invention, there is a method of providing an RVT for an object wherein reading of said TR, EI's, and/or HTE's is reading from a blockchain record storing up to all of said RVT, TR, EI's, and/or HTE's.

According to an eighteenth aspect of the invention, there is a method of providing an RVT for an object wherein reading of said TR, EI's, and/or HTE's is reading from a hashgraph record storing up to all of said RVT, TR, EI's, and/or HTE's.

According to a nineteenth aspect of the invention, there is a method of providing an RVT for an object wherein rein said FIJI and said SUI are a-fixed connectively to said object in the form of a device having a physical media having storage.

According to a twentieth aspect of the invention, there is a method of providing an RVT for an object wherein comprising a consent cloud in the form of a system that compares a plurality of a change, an update, and/or a request for verification of any of said plurality of EI's, and said plurality of HTE's, said TR, and/or said RVT to enable able said change, said update, and/or said request.

An advantage of the present invention is that it resolves the access and transaction data sharing issues present in the prior art by enabling and/or enhancing the tracking and verification of authenticity (chain of custody) for any uniquely identified object or constituent component thereof because it can be embodied, as herein described, in the highly portable, flexible, reliable, and scalable computer hardware and software systems in the form of a user device accessing an application operating on a processor having and incorporating access to all manner of database technologies.

An advantage of the present invention is that it resolves the inconsistencies in data records (transactions) for physical goods (objects), and the resulting potential transaction/date falsification issues present in the prior art by incorporating a second unique identifier linked to a first unique identifier associated/linked with an object thereby effectively enabling a traditional two-factor style authentication for transactions involving the creation, movement, and consumption of manufactured objects (products and materials). A further advantage of the present invention is that it further resolves the lack of authenticated data among the prior art for transactions involving the creation, movement, and consumption of manufactured objects (products and materials).

The invention will now be described, by way of example only, with reference to the accompanying drawings in which:

### BRIEF DESCRIPTION OF THE SEVERAL VIEWS OF THE DRAWINGS

FIG. 1 illustrates automatic data capture utilizing a transaction input device 2001, of a first unique identifier, comprising an Item ID (FUI) (or unique electronic tracking identifier), 1012, derived from an identification designation scheme, 1011; further said Item ID (FUI) is associated with additional data, which may include a second unique identifier 102 (SUI) and/or may include additional information, including a first additional data element 201, a second additional data element 202, a third additional data element 203; further depicting a distributed ledger data system 301, operatively connected with a first comparison algorithm 400, further said distributed ledger having said first unique identifier associated with said additional information stored within a database comprising 4001, 4002, 4003, 4004, according to one or more aspects of the disclosure;

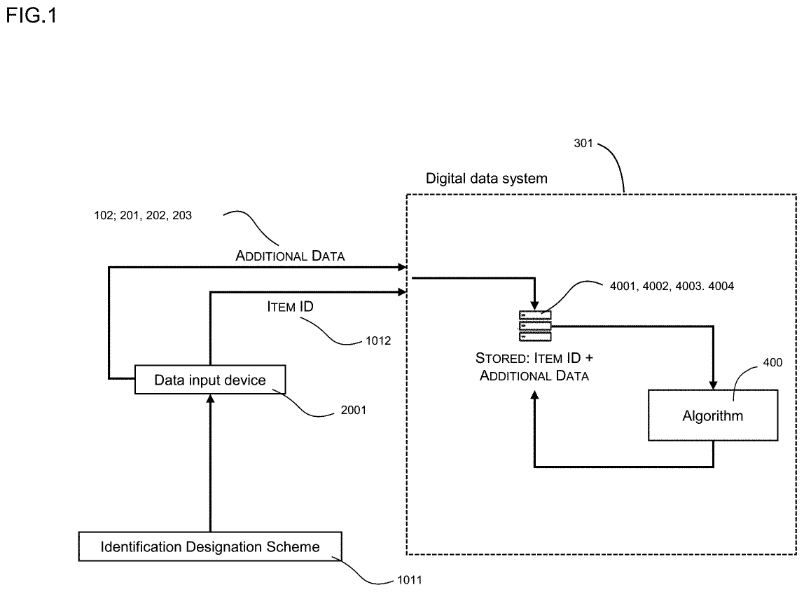

FIG. 2 illustrates a physical medium 1000 having a first unique identifier 101 (FUI), and a second unique identifier 102 (SUI) stored within physical memory 1001, 1002 respectively; where automatic data capture is performed, at least partially, through inductive coupling with said physical storage medium; further with cryptographic encoding at time of transmission, such as RFID 20012; Further, a transaction input device assists in communication, 20011 with a cloud distributed ledger with cloud access protocols 300; Allowing for a first comparison algorithm 400 and the following authentication steps 402; Receiving said first unique identifier coupled with said second unique identifier 103, further associated with at least one first additional data element 201 comprising of physical attribute information to be stored; Comparison to said first unique identifier associated with said second unique identifier stored within said distributed ledger including databases; Determination that received first unique identifier coupled with said second unique identifier is equal to stored first unique identifier associated with said second unique identifier, utilizing a database 4001; Storage of said first additional data element in association with said first unique identifier coupled with said second unique identifier within said distributed ledger, including database 4002, according to one or more aspects of the disclosure;

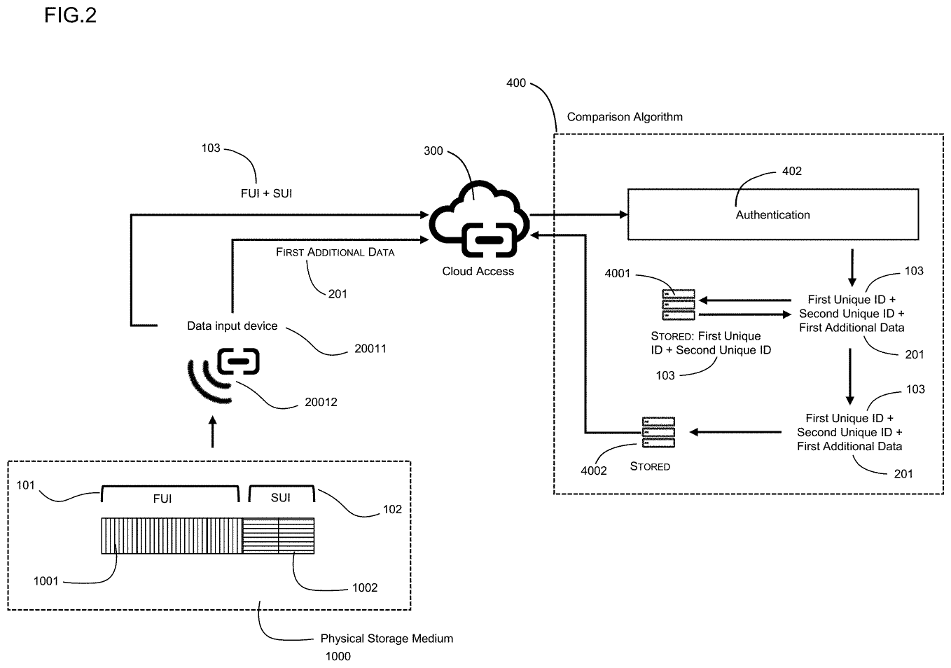

FIG. 3 illustrates a physical medium, 10011, having a plurality of first unique identifier stored within, 10001 and 1001, and a second unique identifier stored within 1002; where automatic data capture is performed, such as a barcode scan by device, 20013, that only reads FUI, 101 from 10001; Further, a transaction input device, 20011 assists in communication with a cloud distributed ledger; Allowing for a first comparison algorithm and the following association steps 403; Receiving said first unique identifier (FUI) 101 associated with at least one second additional data element 202; Storage of said first unique identifier in association with said second additional data element within said distributed ledger including database 4003; according to one or more aspects of the disclosure;

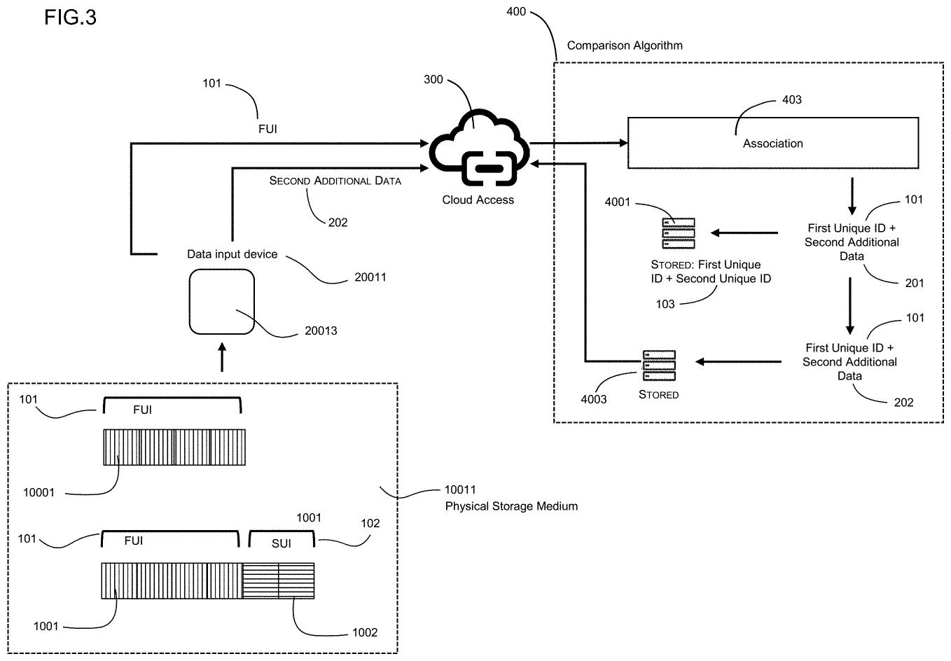

FIG. 4 illustrates a first comparison algorithm providing the following mathematical coupling steps 404; Further; Receiving said first unique identifier coupled with second unique identifier, further associated with at least a third additional data element 203; Comparison to said first unique identifier associated with second unique identifier stored within said distributed ledger including database; Determination that received first unique identifier coupled with said second unique identifier is equal to stored first unique identifier associated with said second unique identifier; Storage of third additional data element in association with said first unique identifier coupled with said second unique identifier within said distributed ledger; Comparison of third additional data element with second additional data element; Determination of mathematical association of said second additional data element to said third additional data element; Storage of said mathematical coupling 405 within said distributed ledger including database 4004, according to one or more aspects of the disclosure;

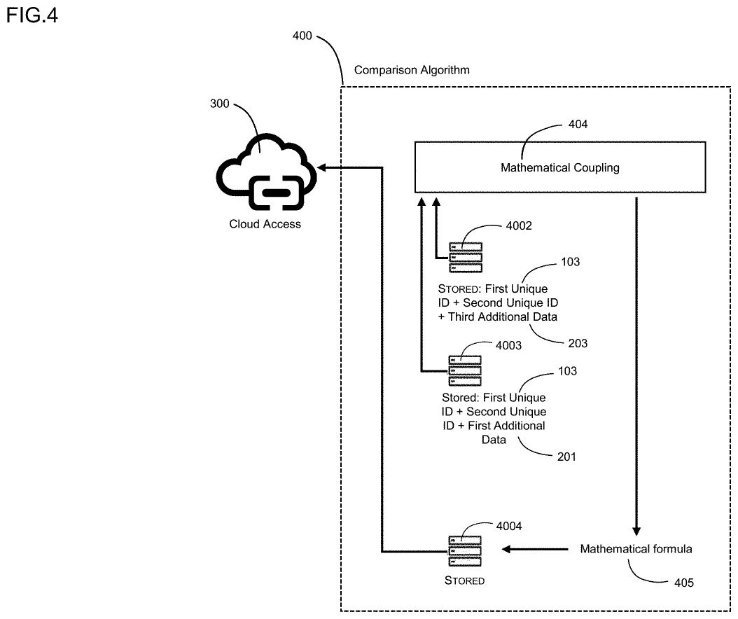

FIG. 5 illustrates a physical medium having a first unique identifier and a second unique identifier stored within; where automatic data capture is performed; further, a transaction input device 2000 in communication with a cloud access protocol including database 4002, further connected to a first comparison algorithm operating on a data system 4000, further connected to a plurality of distributed ledgers 6000, including data connected to a supplier 6001, a manufacturer 6002, and a distributor 6003; where said distributed ledger comprising at least one blockchain of linked records 6100. Said blockchain of linked records comprising first additional data element comprising of physical attribute information 6101 (FUI+SUI+data elements), linked to a second additional data element 6102 (FUI+data elements), further linked to a third additional data element 6103 (FUI+SUI+data elements); including additional linkages 6104, according to one or more aspects of the disclosure;

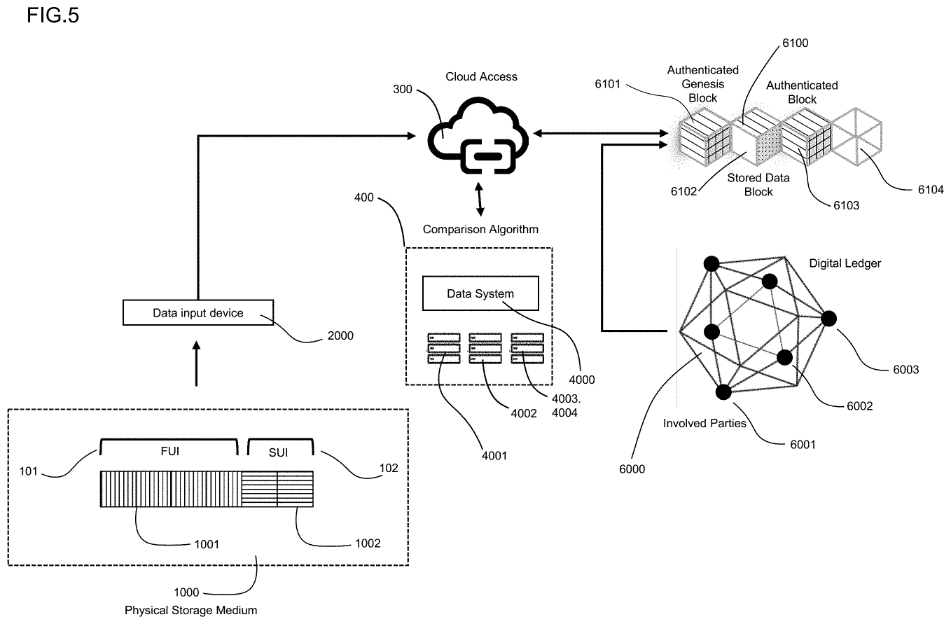

FIG. 6 illustrates a distributed ledger comprising a plurality of blockchains of linked records 6200, 6300, 6400, 6500, 6600, comprising data elements of physical attribute information from a supplier 6001, a manufacturer 6002, and a distributor 6003. Physically authenticated genesis block 6201; protected viewing block 6202, additional data blocks 6203, shared physically authenticated blocks 6204, 6301, 6401, shared additional data blocks 6205, 6305, 6405, internal restricted access blocks 6303, 6403; cross partner restricted access blocks 6502, 6602; shared physically authenticated blocks 6304, 6404, 6501, 6601, shared public blocks 6206, 6306, 6406, 6506, 6606, according to one or more aspects of the disclosure;

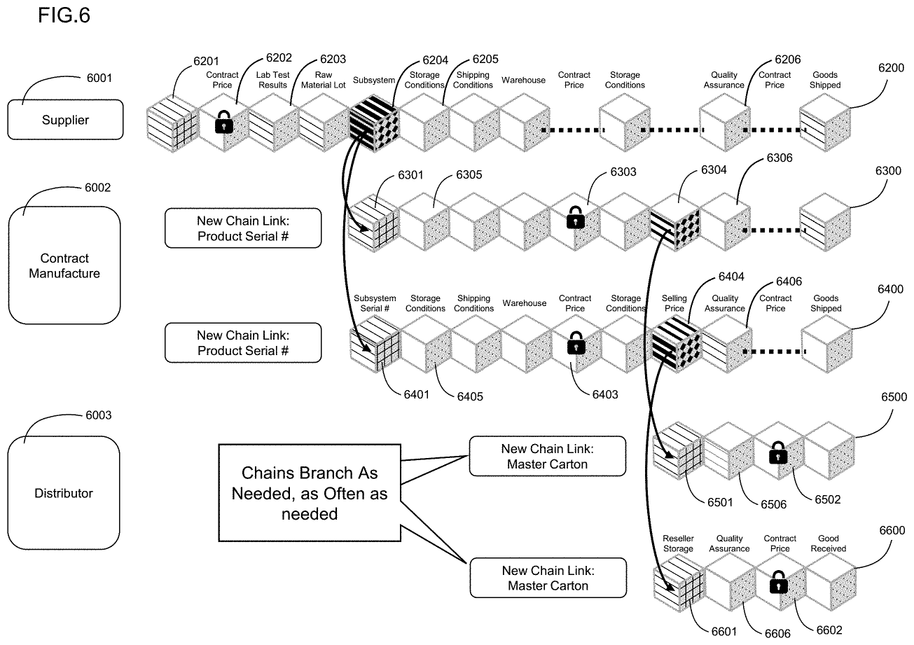

FIG. 7 illustrates a transaction input device 2001, and transaction input device 20011 in communication with a cloud distributed ledger with cloud access protocols 300, connected to data portal 4100, connected to an existing manufacturing management system 6003, through use of a dedicated gateway connection 4001 at a similar physical location of data capture 6005, operatively connection to a shared database 6004 within said management system 6003, comprising a warehouse management system 601, an enterprise resource planning 602, a manufacturing execution system 603, and additional systems required 604, according to one or more aspects of the disclosure;

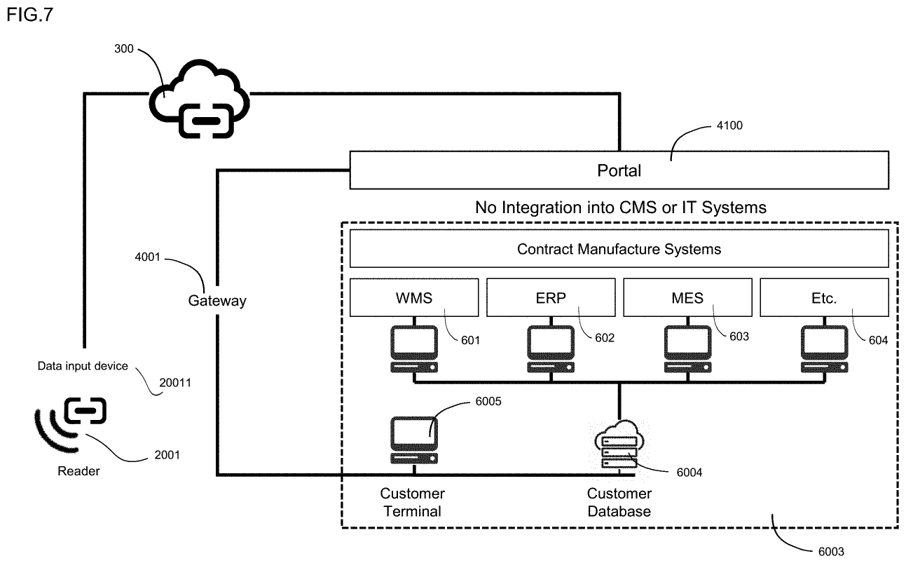

FIG. 8 illustrates the difficulties of tracking physical products in an exemplary supply chain consisting of data elements of raw materials 7001, 7002, connected to a data element of a contract manufacture 7003; further data elements of subsystem components 7009, 7010 connected to a second data element of a second contract manufacture 7011; yet further connected to a multiple of data elements of factories 7004, 7012; further connected to a multiple of data elements of inventory locations 7005, 7013; further connected to data elements of a multiple of distribution locations 7006, 7014; yet further connected to data elements for a multiple of retail locations 7007, 7008, 7015, 7016, according to one or more aspects of the disclosure;

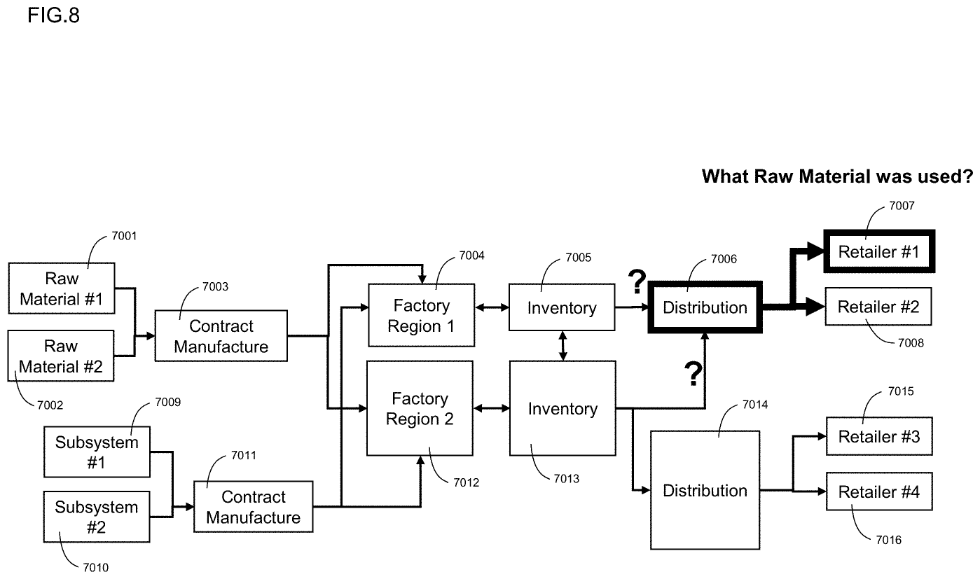

FIG. 9 illustrates data elements connected in a branching linear method, where said data elements are simultaneously shared, utilizing at least one blockchain of linked records, where 7017 represents the full set of branching data elements 7006, 7014; further where 7018 represents the full set of branching data elements 7007, 7008, 7015, 7016; according to one or more aspects of the disclosure; and

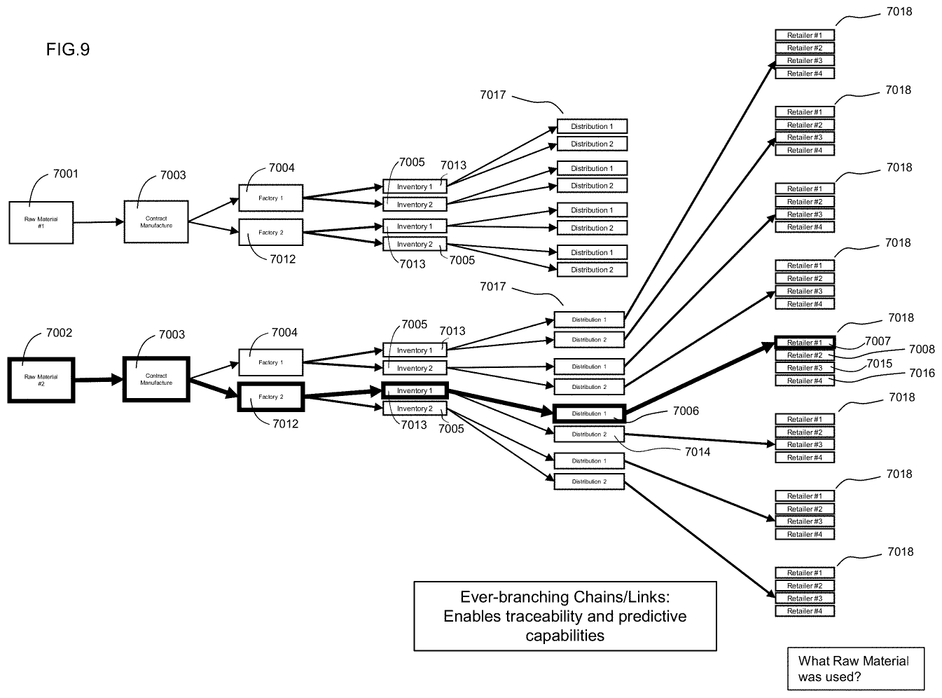

FIG. 10 illustrates an exploratory product assembly factory with physical authentication through automatic identification and data capture 8001, comprising a plurality of assembly stations 800 combine with automatic inspection 808, 809; further compared to an exploratory product assembly without physical authentication 8002, comprising a plurality of assembly stations 806, thereby requiring additional time to assemble a similar product, further requiring additional resources to perform an audit of final product production 810. The figure further illustrates said automatic identification and data capture assembly station 800, comprising parts 801, an RFID reader 802, a product assembly 803, an assembly operator 804, and transfer 805 to an additional station 800. The figure further illustrates where said assembly station 806, comprising parts 811, a barcode reader 807, a product 812, an assembly operator 813, and transfer 814 to an additional station; according to one or more aspects of the disclosure.

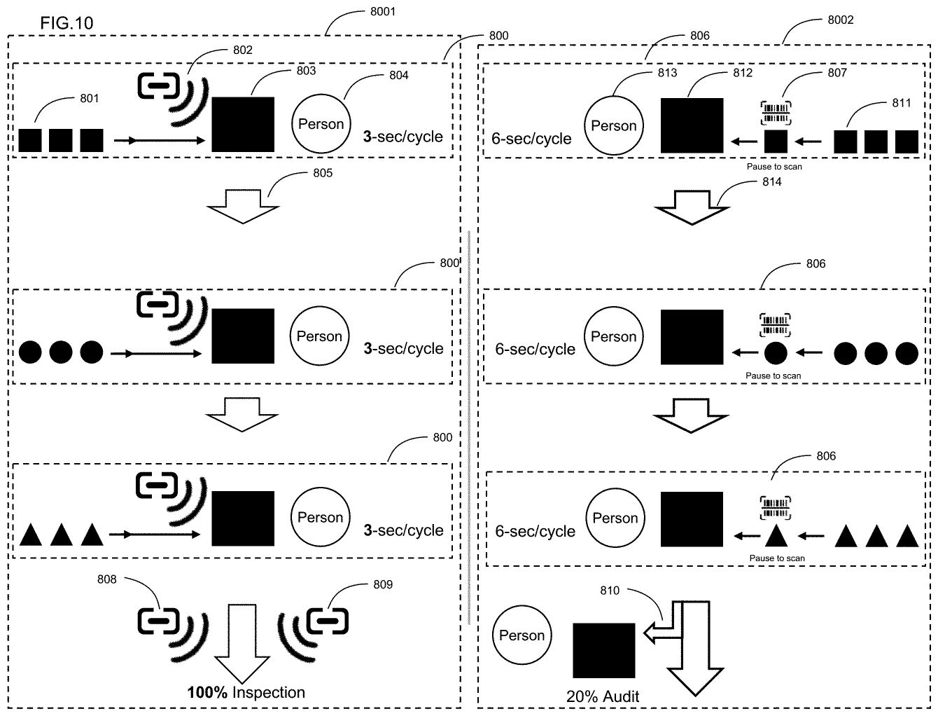

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “an embodiment,” “a preferred embodiment,” “an alternate embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Throughout this specification, the word “object”, or variations thereof such as “objects”, will be understood to imply the inclusion of any physical item, and/or any material thing that can be seen and touched. Some examples include, products, materials, possessions, and items of manufacture.

Throughout this specification, the word “link”, or variations thereof such as “linked”, “linking” or “links” will be understood to imply associating by at least electronic or digital connection the two things begin referred to as having a link or linked to each other. One example is when a first unique identifier (FUI) is linked to a second unique identifier (SUI), wherein since the FUI represents the item itself (the object), and the SUI may be represented in the inductive coupling media attached to the object, in which both the FUI and SUI are encoded (but in different locations on the chipset of the media), with both the object and the attached media moving as one. And depending on the data capture technology used at the location where the transaction (interaction with the object) is being conducted, both the FUI and SUI would be expected to be captured in the same transaction when using an inductive coupling device, but only the FUI would be expected to be captured and included in the transaction when the media is “read” using a line-of-sight image technology device, such as barcode/QR code readers or image device capable of identifying text from an image. This example is an SUI getting a link to and FUI. Linking includes any form of one-way formation of association/connectivity for two or more elements.

Throughout this specification, the phrase “evaluation indices”, or variations thereof such as “evaluation index”, will be understood to imply any combination of a weighting criteria, a pattern, a range, a quantity, and/or a value for at least one of a device ID, a device description, a transaction ID, a date/time stamp, a type of transaction, a location data, a UETI, a FUI, and/or a transaction event. One example of an evaluation index is a zero to one numeric scale wherein a an transaction having a relationship to multiple transactions verifying the content of said transaction would get a higher value than a transaction having zero or one relationship to other transactions. This list of possible evaluation index elements is representative of currently considered elements, but is not listed as a means of limiting them to this list. Others may develop over time and may be transactionally or industry specific, or may be broad in scope, for comparative purposes.

The present invention is a system and method for providing physically authenticated digital tracking and association for manufactured objects and the raw materials associated therewith for the purpose of providing a representative value of trust for a transaction record linked to said manufactured objects and said raw materials associated therewith to enable and/or enhance tracking and verification of authenticity (chain of custody) of said manufactured objects and said raw materials associated therewith.

Either in manufacturing or some time after, the manufacturer or owner of an item/object assigns a representative unique ID to the item. As a unique ID, it is not to be duplicated on any other item anywhere else in the world, once assigned to the item. Upon being commissioned by the manufacturer/owner of the item, that unique ID can only be used to reference that unique item. It is a one-time assigned reference ID. This commissioned ID is used as the first unique identifier (FUI) of the item/object.

Upon commissioning and assignment of the FUI to the object, the manufacturer/owner of the object then applies and assignees the physical media directly to the item or packaging of the item. The media contains its own pre-assigned unique identifier hard coded to the storage component of the media and is unchangeable once coded. That unique ID, which is assigned by the manufacturer of the media, represents the media itself, and is only capable of being systematically ready through inductive coupling. There is no printed representation of that unique ID anywhere on the media. During the process of applying the media to the item/object, encodes the FUI into an accessible portion of the storage component of the media, as the item/object FUI. Upon successful encoding of the FUI to the media, the manufacturer/owner of the item/object reads the unique ID of the media through inductive coupling, and assigns the unique ID of the media as the second unique identifier (SUI) of the item/object. The FUI may then be represented in a printed form on the outside of the media, for capture either by optical electronic data capture (barcode/QR code/image capture) or by physical viewing. Upon completion, a transaction is generated establishing the association of these data elements to represent the item to which the media has been applied. These two identifiers (FUI and SUI) are systematically coupled together and stored (UETI), to represent the item/object at whatever level the media is applied. If the media is applied to the packaging of the item, then it represents the packaged item. If it is applied to the item itself, inside of the packaging, then it represents the item/object inside.

The physical item/object can be referenced by capturing the item reference data from the media, to represent the physical item. Depending on the data capture technology, the item/object may be able to be identified, even if the item/object is obscured from physical viewing. While the item/object may be under, behind or inside of something else that may be obscuring it from view, certain induction coupling capabilities of certain data capture devices may be able to communicate with the media to collect the accessible data stored on it, matching the UETI of the item/object. Thereby identifying the existence of the item, even when obscured from view (since both the FUI and SUI are captured together and verifiable as a linked data set), and doing so in an automated systematic fashion. Additionally, other data capture devices utilizing line-of-sight optical technology (such as barcode/QR Code/image capture), may be able to read the printed representation of the FUI in an automated systematic fashion, only when the media applied to the item/object is NOT obscured from view (other environmental limitations of these data capture technologies may apply).

The present invention offers the inherent extra security (essentially a two-factor verification) enabled using a data capture device with inductive coupling technology. The means of being able to capture the SUI and FUI together allows for a more immediate verification of the item/object by fully validating the presence of the media applied to the item, not just capturing the FUI of the item/object by line-of-sight technologies. Since line-of-sight data capture technologies can do so only by viewing a printed representation of the FUI, the data can be captured by any printed representation of it. So multiple printings/copies can be generated. While this type of technology can be used for conducting automated data capture and can help reduce operational processing costs, it doesn't ensure authenticity, or the actual presence of the item/object. An example can be provided by considering the use of “cheat sheets”. Often in automated operations, when pallets of products are being produced. The pallet will often have a printed “cheat sheet” applied to the outside of it, with printed representations (often barcodes) of the IDs of the items contained within the pallet. This allows the operation to just scan the printed representations, when loading a trailer, to assign those IDs to that trailer/manifest. Since it would be cost prohibitive to open the pallet and physically verify every item, and then re-wrap each pallet, prior to loading. This is often a very common practice in outbound operations.

The system and method of the present invention provides a much higher trust calculation for items/objects captured and identified in a transaction record through the use of induction coupling data capture technologies and devices. But all the other data elements of an item moving through a supply chain are also valuable in determining how trust-worthy a transaction record is, that indicates an item was received at a particular location and time. As further indicated in additional comments within this document, all of the data elements identified within a transaction record (whether it be a record of initial creation, operational processes, inventory storage, shipping, receiving, handling, ownership transfer, physical movement/location, environmental impact, or surrounding sensor data, usage, disposal, recycling, etc) become traceable and comparable to all other transaction data records stored for the same item/object. Nothing moves in a vacuum. Therefore, every other action, interaction or commonality occurring with or around the movement being tracked becomes a data element of the movement. Identifying the item/object itself isn't enough, it then has to be considered in context with everything else around it. All of these other pieces of information are critical in determining our understanding of the item/object and to what extend we can trust what we're being told about it. Another important factor remains. While the transactions must align appropriately, in the absence of certain data elements, it's also critical to ensure that transactions don't at least contradict one another.

For example, the media applied to a product can end up getting damaged during the handling that occurs in a supply chain while transporting and moving items around. Given that the identification of the item/object itself is such an important element in establishing a trust value, the process for dealing with a damaged media is equally critical. If for any reason the media is damaged, a replacement media must be provided. Strict governance is required for such occurrences. Since a unique ID cannot be re-used and the linking of a FIJI and SUI are permanent, the only way to conduct a replacement is to generate a new media, following the original process indicated earlier, and create a transaction record assigning the new linked UETI information as a ‘replacement’, moving forward, for the original data pairing, and assigning that transaction to the original UETI. The original media is removed and considered destroyed at the time of the transaction record. This transition record, representing the replacement, ensures all prior data and future data have a transaction linking them together, which becomes part of the primary data stored regarding the item/object. This also creates a security checkpoint. If at any point afterward, a transaction occurs containing the original pairing, it becomes a data contradiction when conducting a comparison of data in a transaction record. it draws attention to the mismatch and requires attention to investigate the cause of the mismatch and all transactions that may be involved. Additional transactions may occur to correct the mismatch issue, and address the cause (whether due to innocuous error or malicious intent).

The present invention provides a representative value of trust in the individual transaction's occurrence, by comparing the transaction data to all of the known information about the item and its journey. The solution provides a trackable map of trust for manufacturers, distributors, retailers, consumers, recyclers, and anyone who has a vested interest in how authentic an item is. It provides an ability to automate transactions and operations in manufacturing, distribution, logistics, receiving and shipping; it can automate inventory management at the item level, and not just the possible quantity of a SKU; it enables the foundational data elements required for true omni-channel operations, by validating which item it is and assigning it based on the most efficient and economical means of fulfilling a customer need; it can provide an end-user consumer with the peace of mind that what they purchased is what they received, as well as functioning as a decision making point in choosing one manufacturer/retailer over another; it can verify sustainability claims that drive certain consumer behaviors; it can be used to track disposal and recycling, both for government compliance and to combat counterfeit operations, by knowing that critical components were recycled/disposed of properly instead of ending up on the black market; it can be used to track counterfeit activity, to target those operations and report to government/law enforcement officials. An item/object receiving a representative value of trust (RVT) (also known as a “Hyper Ops Trust Verification”), helps to drive our entire ecosystem and creates an environment of trust between parties.

The data capture device used to capture the object/item FUI, may not be capable of capturing the item/object SUI. It may only be capable of reading the physically printed representation of the FUI by technologies such as barcode or QR code reading. Therefore, the comparison of the transaction record pertaining to the reference of the item would only be able to be compared to the FUI, even if the item is legitimate and contains an SUI. The lack of the SUI data element in a transaction record generated using a data capture device with such a limitation does not cause a rejection of the record, or necessarily indicate that the record cannot be trusted in any way. The fact that the transaction item comparison could only be conducted on the FUI, just means that the portion of the trust value generated from the item identification would not be as high as the value would have been, if the item was able to be compared against both the FUI and SUI, because of the technical limitation of the data capture device. However, if the data capture device indicated in the transaction record is capable of capturing the SUI data element but fails to provide that data element or provides an incorrect match, the trust value calculation suffers a negative impact. Correct comparison evaluations of all the other data elements in the transaction may match and help to improve the calculated score to an acceptable level, but may not remove all doubt of a transaction that has been negatively impacted. This is where the scaled value of the many data elements of the transaction come into play. Certain confirmed transaction data elements may generate high enough calculated value marks to compensate for other missing or mismatched data elements, while others may not. And certain other more critical missing or mismatched data elements would have a significantly higher impact (either positive or negative) in comparison to other less critical data elements.

With regard to creating the representative value of trust for a transaction record these are some of the transactional trust questions to be asked, which drive the data comparisons resulting in a plurality of evaluation indices:
How well can it be trusted that the item indicated, is the item interacted with?
How well can it be trusted that the location of the interaction is correct?
Does it match with other items indicated as being shipped together with this item?
Is the identified location appropriate for the expected path the shipment would be expected to take?
Does the timing of the transaction fit appropriately for this item to have arrived at this location, giving any prior transaction locations?
Does the timing fit with similar transactions of other items shipped with the indicated item?
Are there an accepted quantity or percentage of other transactions occurring at generally the same time and location, representing other items referenced to be traveling with the indicated item (especially if shipped as an associated item in a homogenous pallet)?
Are any identified physical characteristics (size, weight, etc.) indicated in the transaction matching those indicated in prior transactions, or are there any differences?
Are there any conflicting transaction records that may cause suspicion on any of the data elements of this record (for instance, if there is another record indicating that this item was interacted with x minutes earlier at a gps location that would be y meters away, or a previous record indicates that the item weighed z kilograms more the day before)?
Is the transaction record coming from a known source, from which prior trusted transaction records have been evaluated?
Similarly, is the data capture device, indicated within the transaction record, a known data capture device (with matching meta parameters), from which prior trusted transaction records have been evaluated?

The possibility that the transaction may be generated from a data capture device not capable of reading the SUI (not capable of conducting an inductive coupling) that may be present on the item/object, when generating the transaction record. Therefore, the absence of an SUI, in that case, would not be a negative inference on the trust calculation for comparing the item reference of the transaction. It just wouldn't calculate as high as a transaction from a device that was capable and did provide such data. Conversely, if the device was not capable of such a coupling, but the transaction record did contain a SUI data element, this would be cause for suspect activity in generating the record. Again, many factors involved.

The trust calculations, and therefore trust decision, is with regard to the transaction record, not the object itself. The portion of the trust value relating to the item/object reference within the transaction record is just one of many data elements being compared and evaluated for the transaction record. The present invention does not just calculate trust for the item/object itself, it calculates the trust for the ‘record’ of the transaction/interaction.

The representative trust value is a valuation of trust of the transaction record, captured at available interaction points within the supply chain, where a data capture device is available to capture the FUI, and possibly the SUI, in whatever form they may be present on the item in question. This is why it is calculated on many more data elements than just the ID's assigned to the item and encoded/printed on the storage medium applied to the item. It's not just a calculation of the item identifiers matching, it's a calculation of trust regarding the transaction record. Asking: Was that exact item seen by the device indicated, at this exact point within the supply chain, at the time indicated by the transaction record? Do the remaining data elements support the claim within the record? While the FUI and SUI matches are critical components within the calculation; confirming the item identity is only one of many factors going into the calculated Trust value of the transaction.

One example of a representative value of trust is a rating wherein for ‘Reading and Storing FUI’ for example, having an RFID is greater than printed, further, an encrypted NFC greater than RFID, and further, an RFID_Hashgraph greater than RFID. This rating for a representative value of trust would be eligible for increase when at least one additional data element such as, analysis of location data, or ‘movement data element(s)’ is added.

The occurrence of a confirmed match of both FUI and SUI is not the only accepted data element, but the occurrence of a confirmed match of both, combined with the AutoID device confirmed identifier (known data source or ID data source type) increases the TR of the data element. However, if the data element contains FUI data (say being captured by a barcode or QR code scanner), without SUI data (acquired only from a data capture technology able to access the security measure built into certain AutoID technologies), but remaining data within the transaction record fall within the expected parameters (location, date-time stamp, corresponding data elements recorded at the same point and time) and comply within expected patterns, then the data record may still receive a positive calculated trust value. However, the value will not be as high as what would be assigned, if said record included a SUI match (coming from an AutoID device utilizing a built-in security mechanism of authentication, such as RFID or NFC) and/or came from a known trusted device. Each of these elements, and more, are used to calculate the Trust Value. It's a matter of the transaction data itself; the metadata of the data capture activity; the surrounding data at the transaction location (what else was read along with the item itself?); data from prior transactions of the item (information know about where and when the item was seen prior the current transaction); original shipment parameters; data anomalies occurring anywhere within the shipment; etc. This includes transaction records occurring afterward. If the next transaction record generates a data anomaly, the extent of the anomaly may impact the calculation of the record prior to it. The record trust value may be recalculated to account for an anomaly occurring immediately after it, if the impact of the anomaly is significant enough, or the cause of the anomaly is not readily identifiable.

As in the present invention, an item (object) would have to be interacted with for it to have generated the transaction record being evaluated in the first place. In situations where products within the supply chain are still moving in pallet or case configurations, and hidden items (hidden from view, but present within) are being identified through radio wave communication utilizing one of the AutoID Data Capture technologies already mentioned above, along with the case and/or pallet itself containing its own unique tag and identifiers, associated to those tags/items contained within. In certain circumstances a digital image of an item existing in the location referenced may help in adding value to the confirmation of the item the record references, it may not of itself provide proof that the item pictured is the unique item in reference, without other corroborating data elements (for example the digitally captured FUI, and possibly SUI or other associated items confirmed at the same time).

Some embodiments of the present invention incorporate the use of inductive coupling. Inductive coupling refers to the transfer of energy occurring in an RFID or NFC type where the media (tag), containing the microchip to be communicated with, is excited with energy to allow the wireless communication to occur. This is typically done by the antenna incorporated into the media (tag) receiving an electromagnetic signal from a ‘reader’. Frequently the media does not have a power source of its own and receives all power from the field generated by the reader. However, the media (tag) can also be battery assist (BAP) or full battery powered (Active). In both of those cases the communication distance is greatly increased due to the media (tag) not needing to draw as much energy from the field in order to conduct the activity.

There is no inductive coupling occurring with the object itself. The FUI is the unique identifier assigned to the item/object itself, but it doesn't get encoded on the object, and RFID/NFC are not required in order for the FUI to exist and be assigned. The FUI can exist and be assigned without the need of an inductive coupling technology, such as RFID/NFC. However, a representation of that number must travel with the object. It can be printed directly on the object, or on media applied to the object, in human readable form or in an encoded data capture technology, such as barcode or QR code. Additionally, the media can further be part of an inductive coupling data capture technology, such as RFID or NFC. In which case, the FUI can be encoded to the chip on the media (tag), to allow for the information to be read at a distance without requiring the line-of-sight connectivity required for barcode/QR code/etc (and in large quantities, captured in milliseconds, as compared to the “one at a time” nature of barcode/QR code/etc.). It's important to keep in mind that when inductive coupling does occur, it is only within data capture technologies that utilize such a means, and the coupling occurs between the reader and the media that is or will be attached to the object, not the object itself.

Additionally, while some media can be designed with additional user accessible memory space, allowing for additional data to be encoded on it, this is not a very common practice. Primarily due to the added cost and complexity of managing that memory space. So it cannot be expected that any additional data (including physical attribute data elements) will be able to be encoded on the media. This type of data capture technology also includes an unchangeable block of memory on the chip, that is pre-encoded by the manufacturer of the chip. It includes a unique identifier that represents the chip (and in essence, the media). This hard coded unique identifier functions as the SUI, and is only available to be captured and linked, when utilizing a data capture technology such as RFID/NFC. If this type of data capture technology is not used, then there is no SUI data available to be captured and assigned. It is an inherent security feature built into RFID/NFC chipsets, and functions as a type of 2-step authentication, and does not exist for barcode/QR code.

Any physical data elements would be assigned to the FUI only (since that is assigned to represent the actual object), with the SUI (Only when an appropriate data capture technology, such at RFID/NFC, is used at the time of genesis) functioning primarily as an authentication element for appropriate identification of the object. None of the below mentioned indices or data elements would be assigned to the SUI. They would only be associated with the FUI, since that unique identifier represents the actual object itself. The confirmation of the FUI (representing the object, and having been assigned by the manufacturer/owner of the object, not by the HyperOps system/method) in evaluating the transaction record, by use of inductive coupling, creates a much higher trust value (due to the inherent 2 factor authentication of the SUI) than if the FUI were only provided by means of printed representation (barcode/QR code/image capture).

Presently, the SUI is only possible if the manufacturer/owner uses a technology which includes inductive coupling. Such as RFID/NFC. If the manufacturer uses an image based technology, such as barcode/QR code/image capture, then there would be no SUI. There would still technically be a UETI, but the SUI portion would be empty.

There are options for creating an SUI with image based technologies (which would be less secure, therefore still generate a lower trust value, but still higher than just having the FUI) or adding an inductive coupling media elsewhere in the supply chain, but these are developmental areas to be explored with funding.

Alternative embodiments of the present invention can incorporate Hashgraph technology. Hashgraph is a patented distributed ledger that uses ‘gossip about gossip’ and a virtual voting system. This information (gossip about gossip) is randomly distributed though the network. One major issue with voting systems, including Hashgraph, is the susceptibility to thirty-four percent corruption (mathematical proofs document this apparently.) In our application, the HyperOps application, by integrating the ‘physical media’ directly with distributed ledger (in direct communication with the digital ledger), example, inductively coupled RFID tag memory (the ‘gossip about gossip’ as written to the RFID tag memory), the physical items can keep the distributed ledger more secure and outnumber the databases/computer node quantities, making it near impossible to produce enough computers to gain greater than thirty-three percent corruption.

Regarding embodiments of the present invention indicating the use of Hashgraph. While the intent is to use a Distributed Ledger Technology (DLT) as part of the blockchain sharing element of the solution, we do not limit to a particular DLT in the patent claim, given expected development in this space over time.

The invention is for a physical authentication trust factor system for the transaction record (every transaction record individually, but affected by how they associate together to represent the entire viewable life-cycle of the object). Each record is evaluated on all the data elements of the transaction, and compared and calculated against all the history of transaction records available regarding the object. A critical minimal element for determining the representative trust value for the transaction record is the data element of each transaction that represents the Object Identification. This is where the UETI comes into play in determining how high the calculated value is for this data element (and in turn impacts the overall score for the transaction record).

It is the FUI that links all of the transaction records together (since it is required and must be available for any transaction record) and to the object itself. The SUI (when used and available to be captured, depending on the data capture technology used at the time of commissioning/genesis, as well as which technology is used at the time of interaction generating the transaction record) is only assigned and used when an induction coupling technology and media are used at the time of commissioning/genesis and is only included in a transaction record when that same technology is used at the time the transaction record is being generated. It only functions as an authentication/security measure when evaluating the object identification data element of a transaction. It is not searchable by itself and does not have any direct connection to any of the other data elements of the transaction to be evaluated and compared for calculation in the overall trust value of the transaction record.

The invention incudes a representative value of trust for a transaction record involving a unique object. The data element containing the object identification is only one of the data elements to be evaluated in determining the trust value of the overall transaction record. The system expects, at a minimum, the object is identified by the FUI. Although possible, the system and method of the present invention does not generally allow a lookup solely by SUI.

The trust determination all data elements (parts) of the transaction record are evaluated the same way, regardless of whether the object transaction record is generated using RFID/NFC or barcode/QR code. Whether the data capture device is RFID or NFC reading the appropriate media for that device and can capture both the FUI and SUI or the data capture device is line-of-sight image capture, such as barcode or QR code, reading the appropriate printed image for that device and can only capture the FUI, in either case, those pieces of information are first and foremost used to evaluate the Object Identification data element(s) of the transaction record. The FUI of the transaction record links the record to the object transaction history, so it can be evaluated in reference to all the other transaction records for the object.

The linking of the two IDs (FUI and SUI) as a UETI is primarily for an additional authentication/security measure when RFID/NFC are being used, and bump the calculation value for the object identification data element. However, once the two are linked, they cannot be unlinked. That's why the entire media has to be disposed of, and replaced with a new set of ID's and a transaction recording the replacement event, when the media has to be replaced due to damage.

In embodying the present invention, it is useful when thought of in terms of the equipment and materials used at the time of commissioning (genesis), in relation to the equipment available at the time of reading (when a transaction is occurring) to consider these parameters:

At the time of commissioning/genesis the manufacturer/owner has access to a label printer and can only create a printed version of the FUI in barcode/QR code, with a human readable (visible) representation of the FUI and applies the label media to the outside of the object. In this case, the genesis transaction added to the database will only contain the FUI, to be used in the UETI. Since there is no ability to assign an SUI (remember that the SUI comes from the hardcoded chipset of the inductive coupling media itself, and since this genesis transaction wasn't conducted using that technology, then a SUI is not possible at that time).

As long as this is the case, the object can only be identified using one of the image capture technology devices, such as barcode, QR code or other image capture capable of identifying text from an image. So, as the object moves through the supply chain, it can only be identified into transactions by line-of-sight un-secure data capture means. Therefore, any transaction referring to interaction with an object that can only be identified in such a way, is suspect, and has an inherently lower trust. The reason for this is because those technologies rely on simple printed labels containing those visual representation. Which can easily be reprinted and applied anywhere, and a high risk for counterfeiting. Someone can easily print the same image representation of the FUI to another label and apply it to something else that is not the item the FUI refers to and send that through the supply chain. This is exactly the way barcode and other labeling is conducted today, and it is at extremely high risk for nefarious activity. With such a high risk of counterfeit due to the technology, the calculated trust value for the item identification portion of any transaction, in which such technology is used, starts off with a low score. However, the overall trust value of the transaction is then increased for every other data element that is determined to match expectations, when compared to the historic information in the database. (Keep in mind that the object identification data is only one of many data elements used to determine the trust score of the transaction).

As indicated above, when utilizing such a means of attaching the UETI (in this case only containing an FUI) to the object means it can only be identified using the same flawed risky technology. If the object passes through a field generated by an induction coupling device (RFID/NFC), the object would not be “seen” by that system. It would have to be captured by a subsequent line-of-sight image technology device. The device ID, type of device and location information would all be included in the transaction record being evaluated for a trust score. Any transaction generated by such a device, should only contain the FUI being represented in the printed form on the label. If an SUI were included in the transaction record, then the transaction would both have a very low trust score, and be flagged as suspect for two reasons:

The device is not capable of capturing an SUI (which can only be captured using inductive coupling technology). So the data had to be included in the transaction record by some other means. The historic data match of the UETI would fail, because the SUI portion of the UETI would be empty (since no SUI exists for the object, due to no inductive coupling media being used). In this case, the genesis transaction added to the database will contain both the FUI (created by the object manufacturer/owner at the time of commissioning/genesis) and the SUI (created by the manufacturer of the induction coupling media, and hardcoded to the chipset contained within it), to be used in the UETI. During the commissioning process, when the test encoding of the FUI is deemed successful, the induction coupling device captures the media ID and assigns it to the SUI (be means of the UETI) in our system, forever linking those two IDs from that point on. As in the scenario above, it is more than likely the commissioning process would include printing a visible representation on the outside of the media using one or more of the image technologies (barcode, QR code, printed readable text), to allow for the widest possible opportunities for the object to be identified within the supply chain, using whatever data capture technology may be available at the point of interaction.

With the object having so many data capture technologies applied, there is a higher possibility that the object can be “read” into many more transaction records occurring in more remote and far-reaching locations globally. Whether an operation contains a large infrastructure of devices, either fixed or handheld within a facility, or an operation uses cloud connected mobile phones in the middle of the jungle/ocean/mountains running apps that control camera functionality for data capture, internal NFC reader capabilities or connect to other mobile/wearable devices via Bluetooth or other wireless means.

If the object is captured into a transaction using an induction coupling technology device, then the device would be capable of capturing both the FUI and SUI (SUI not visible at all on the object) data elements into the transaction. The device ID and device type are used to identify which data capture technology is being used (additionally, in a fixed read location, this also allows for comparison of the transaction location information to the historic location of the device, not just in comparison to the location data of prior transactions). If the device is capable of induction coupling, and the media applied to the object provides for induction coupling, then the transaction should contain both the FUI and SUI of the UETI. The transaction would receive a higher trust value for the object identification data element of the transaction if (all of the following is true):

The device was an induction coupling device.

The media was an induction coupling media.

At the time of commissioning/genesis the manufacturer/owner has access to equipment and materials for printing and encoding media with inductive coupling, and does so using RFID/NFC along with printing the barcode/QR code and human readable (visible) version of the FUI (only) on the media, and applies the media to the object.

Both the FUI and SUI were provided in the transaction record.

Both the FUI and SUI matched the historic record for the UETI.

The transaction would receive a lower trust value for the object identification data element of the transaction if (all of the blow is true):

The device was an induction coupling device.

The media was an induction coupling media.

The FUI was provided, without the SUI, in the transaction record.

The FUI matched the historic record for the FUI portion of the UETI.

The transaction would be flagged as suspect for the object identification data element of the transaction, requiring investigation, if (all of the blow is true):

The device was an induction coupling device.

The media was an induction coupling media.

The SUI was provided, without the FUI, in the transaction record (FUI is a minimally required data element).

If the object is captured into a transaction by a device using an image capture technology, then the device would be capable of only capturing the FUI from the media. The device ID and device type are used to identify the data capture technology used. Most image capture technologies are only capable of conducting single transactions at a time, due to requirement for line-of-sight to the image being captured. If the object is known to contain an induction coupling media with visible representation of the FUI printed on it, then the device would be capable, and expected, of only capturing the FUI from the media. There would be no mechanism for it to capture the SUI. Therefore, the transaction record would be expected to only contain the FUI of the UETI.

The transaction would receive a lower trust value for the object identification data element of the transaction if (all of the blow is true):

The device was an image capture device (Barcode/QR code/Image of readable text).

The media was an induction coupling media.

The FUI was provided, without the SUI, in the transaction record.

The FUI matched the historic record for the FUI portion of the UETI.

The transaction would be flagged as suspect for the object identification data element of the transaction, requiring investigation, if (all of the blow is true):

The device was an image capture device (Barcode/QR code/Image of readable text).

The media was an induction coupling media.

The SUI was provided, either by itself or along with the FUI, in the transaction record (Even if the UETI were matched to the historic data, due to the fact that the data capture technology used to generate the transaction record is not capable of capturing the data which the transaction record contained)

Regarding embodying a distributed ledger. Storing distributed ledger information on the media would not be possible in all instances. The only media possible to store any additional data on would be if conductive coupling media used for RFID or NFC were procured with ‘additional user definable space’, that could be accessed at the time of encoding. These media (tags) would be higher cost and are usually procured for specific purposes, so the manufacturer of the object could encode uniquely important information that is usually encrypted in some way. When used, most often the encoding entity will lock, and possibly password protect readability of that section of memory, preventing others from adding, removing and possibly even reading what has been encoded in that space. Therefore, if the media is applied in a typical fashion as is most widely done in supply chain today, the largest percent of objects would not be possible to either access or even have the space on them for storing information from our system. However, it is possible that we may offer a service that would enable us to apply such media to objects upon request. For this possibility and the possibility that a percent of objects could potentially have such media available and ‘unlocked’, the present invention includes the possibility of storing part of the hashgraph distributed ledger onto the physical media (essentially the gossip about gossip portion). But this cannot be expected to be the case in all or even a majority of the instances. However, where possible, this would allow for the media itself to function as a node within a hashgraph distributed ledger, and would add stability to combat the possibility of greater than 30% of nodes being corrupted/taken over to sabotage the distributed ledger (which is an inherent risk for blockchain systems).

In a preferred embodiment of the present invention there is a physical authentication trust factor system to create a representative value of trust (RVT) for a transaction record (TR) comprising a plurality of unique electronic tracking identifiers (UETI) each comprising a first unique identifier (FUI) linked to an object wherein said FUI comprises a plurality of FUI data elements one of said plurality of FUI data elements comprising an automatically unique identifier, a plurality of evaluation indices (EI's), said plurality of EI's comprising any combination of a weighting criteria, a pattern, a range, a quantity, and/or a value for at least one of a device ID, a device description, a transaction ID, a date/time stamp, a type of transaction, a location data, a UETI, a FUI, and/or a transaction event, an algorithm, a transaction input device, a database comprising said plurality of EI's, and a plurality of historical transactional events (HTE's) said plurality of HTE's comprising said FUI, said UETI, and any combination of a device ID, a device description, a transaction ID, a date/time stamp, a type of transaction, a location data, a UETI, a FUI, and/or a transaction event, a processor, and a user device, wherein said transaction input device collects a plurality of actual transactional events (ATE's) wherein said plurality of ATE's comprises said FUI and any combination of a first physical attribute of said object, said device ID, said device description, said transaction ID, said FUI, said UETI, said date/time stamp, said type of transaction, and said location data, and said plurality of ATE's is transmitted to said database in the form of non-transitory computer-readable media, and wherein said processor uses said algorithm for a comparison of each of said ATE's to said plurality of EI's and said plurality of HTE's to determine an RVT for said TR.

In an alternate embodiment of the present invention there is a physical authentication trust factor system further comprising a user uses said user device to access said system and query for a report of said RVT by entering any of said UETI or said FUI. Further, optionally wherein said ATE's and said HTE's further comprise a user data entered by said user for inclusion in said comparison step contributing to said determination of said RVT for said TR.

In an alternate embodiment of the present invention there is a physical authentication trust factor system wherein said UETI further comprises a second unique identifier (SUI) associated with said object, and after transmission of said ATE's by said transaction input device when no UETI is linked with said SUI, said processor uses said algorithm to link said SUI to said UETI having said FUI associated with said object. And, further, an embodiment wherein said SUI further comprises an inductive coupling device.

In an alternate embodiment of the present invention there is a physical authentication trust factor system wherein said RVT is adjusted according to a plurality of trust valuations, one of said plurality of trust valuations being an increased value for said RVT when a second unique identifier (SUI) is associated with said object and linked to said FUI within said UETI for said object.

In an alternate embodiment of the present invention there is a physical authentication trust factor system wherein said processor uses said algorithm for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event, then when there exists an EI that matches at least one of said device ID, said device description, said transaction ID, said FUI, said date/time stamp, said type of transaction, said location data, said UETI, and/or said transaction event, and then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT. And, optionally wherein adjustment of said RVT is according to a plurality of trust valuations, one of said plurality of trust valuations being an increased value for said RVT when any of said device ID, said device description, said transaction ID, said FUI, said date/time stamp, said type of transaction, said location data, said UETI, and said transaction event include a second unique identifier (SUI) associated with said object and linked to said FUI within said UETI for said object.

In an alternate embodiment of the present invention there is a physical authentication trust factor system wherein said transaction input device comprises a cryptographic encoding sequence prior to a reading and/or viewing by a user of said SUI.

In an alternate embodiment of the present invention there is a physical authentication trust factor system wherein said database further comprises operational connectivity with a distributed ledger for storing up to all of said plurality of EI's, and said plurality of HTE's.

In an alternate embodiment of the present invention there is a physical authentication trust factor system wherein said database further comprises operational connectivity with a blockchain record for storing up to all of said plurality of EI's, and said plurality of HTE's.

In an alternate embodiment of the present invention there is a physical authentication trust factor system wherein said database further comprises operational connectivity with a hashgraph record for storing up to all of said plurality of EI's, and said plurality of HTE's.

In an alternate embodiment of the present invention there is a physical authentication trust factor system wherein said FUI and said SUI are a-fixed connectively to said object in the form of a device having a physical media having storage for storing any combination of elements from said database.

In an alternate embodiment of the present invention there is a physical authentication trust factor system 1 comprising a consent cloud in the form of a system that compares a plurality of a change, an update, and/or a request for verification of any of said plurality of EI's, and said plurality of HTE's, and/or said RVT to enable able said change, said update, and/or said request.

In a preferred embodiment of the present invention there is a method of providing a representative value of trust (RVT) for an object comprising:

a) reading a at least one transaction record (TR) having at least one unique electronic tracking identifiers (UETI) each comprising a first unique identifier (FUI) linked to said object, said FUI having a plurality of FUI data elements said plurality of FUI data elements comprising an automatically unique identifier, and a first physical attribute of said object; b) reading a plurality of evaluation indices (EI's), said plurality of EI's comprising any of a weighting criteria, a pattern, a range, and/or a value for at least one of a device ID, a device description, a transaction ID, a date/time stamp, a type of transaction, a location data, said UETI, said FUI, and/or a transaction event,

b) reading a plurality of historical transactional events (HTE's) said plurality of HTE's comprising said device ID, said device description, said transaction ID, said FUI, said UETI, said date/time stamp, said type of transaction, and said location data, and

c) comparing each of said TR's to said plurality of EI's and said plurality of HTE's to determine a RVT for said TR.

In an alternate embodiment of the present invention there is a method of providing an RVT for an object wherein said UETI further comprises a second unique identifier (SUI) associated with said object, and when no UETI is linked with said SUI linking said SUI to said FUI associated with said object within said UETI. An, optionally, wherein reading said SUI further comprises an inductive coupling device.

In an alternate embodiment of the present invention there is a method of providing an RVT for an object wherein said RVT is adjusted according to a plurality of trust valuations, one of said plurality of trust valuations being an increased value for said RVT when a second unique identifier (SUI) is associated with said object and linked to said FUI within said UETI.

In an alternate embodiment of the present invention there is a method of providing an RVT for an object wherein said ATE's and said HTE's further comprise a user data entered by said user for inclusion in said comparison step contributing to said determination of said RVT for said TR. User data is only added via a transaction.

In an alternate embodiment of the present invention there is a method of providing an RVT for an object wherein for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event, when there exists an EI that matches at least one of said device ID, said device description, said transaction ID, said FUI, said date/time stamp, said type of transaction, said location data, said UETI, and/or said transaction event, and then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT. And, optionally, wherein said adjustment to said RVT is according to a plurality of trust valuations one of said plurality of trust valuations being an increased value for said RVT when a second unique identifier (SUI) is associated with said object and linked to said FUI within said UETI.

In an alternate embodiment of the present invention there is a method of providing an RVT for an object wherein reading of said TR, EI's, and/or HTE's is reading from a distributed ledger storing up to all of said RVT, TR, EI's, and/or HTE's.

In an alternate embodiment of the present invention there is a method of providing an RVT for an object wherein reading of said TR, EI's, and/or HTE's is reading from a blockchain record storing up to all of said RVT, TR, EI's, and/or HTE's.

In an alternate embodiment of the present invention there is a method of providing an RVT for an object wherein reading of said TR, EI's, and/or HTE's is reading from a hashgraph record storing up to all of said RVT, TR, EI's, and/or HTE's.

In an alternate embodiment of the present invention there is a method of providing an RVT for an object wherein said FUI and said SUI are a-fixed connectively to said object in the form of a device having a physical media having storage.

In an alternate embodiment of the present invention there is a method of providing an RVT for an object comprising a consent cloud in the form of a system that compares a plurality of a change, an update, and/or a request for verification of any of said plurality of EI's, and said plurality of HTE's, said TR, and/or said RVT to enable said change, said update, and/or said request.

An advantage of the present invention is that it resolves the access and transaction data sharing issues present in the prior art by enabling and/or enhancing the tracking and verification of authenticity (chain of custody) for any uniquely identified object or constituent component thereof having a first unique identifier because the present invention can be embodied, as described above, embodied in the highly portable, flexible, reliable, and scalable computer hardware and software systems available today in the general form of a system using a method of a user device accessing an application operating on a processor having and incorporating access to all manner of database technologies. Further, as above with the addition of any or all of encryption, distributed ledger, blockchain, hashgraph, and/or localized object/tag based data storage technology the access and transaction data sharing issues present in the prior art are overcome.

An advantage of the present invention is that it resolves the inconsistencies in data records (transactions) for physical goods (objects), and the resulting potential transaction/date falsification issues present in the prior art by incorporating a second unique identifier linked to a first unique identifier associated/linked with an object thereby effectively enabling a traditional two-factor style authentication for transactions involving the creation, movement, and consumption of manufactured objects (products and materials).

A further advantage of the present invention is that it further resolves the lack of authenticated data among the prior art for transactions involving the creation, movement, and consumption of manufactured objects (products and materials). Even further, as above with the addition of any or all of encryption, distributed ledger, blockchain, hashgraph, and/or localized object/tag based data storage technology the inconsistency and authentication issues present in the prior art are overcome.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A physical authentication trust factor system to create a representative value of trust (RVT) for a transaction record (TR) comprising
a plurality of unique electronic tracking identifiers (UETI) each comprising
a first unique identifier (FUI) linked to an object wherein said FUI comprises a plurality of FUI data elements one of said plurality of FUI data elements comprising an automatically unique identifier,
a plurality of evaluation indices (EI's), said plurality of EI's comprising any combination of a weighting criteria, a pattern, a range, a quantity, and/or a value for at least one of a device ID, a device description, a transaction ID, a date/time stamp, a type of transaction, a location data, a UETI, a FUI, and/or a transaction event,
an algorithm,
a transaction input device,
a database comprising
said plurality of EI's,
a plurality of historical transactional events (HTE's) said plurality of HTE's comprising said FUI, said UETI, and any combination of a device ID, a device description, a transaction ID, a date/time stamp, a type of transaction, a location data, a UETI, a FUI, and/or a transaction event,
a processor,
a user device,
wherein transaction transaction input device collects a plurality of actual transactional events (ATE's) wherein said plurality of ATE's comprises said FUI and any combination of a first physical attribute of said object, said device ID, said device description, said transaction ID, said FUI, said UETI, said date/time stamp, said type of transaction, and said location data, and said plurality of ATE's is transmitted to said database in the form of non-transitory computer-readable media,
and wherein said processor uses said algorithm for a comparison of each of said ATE's to said plurality of EI's and said plurality of HTE's to determine an RVT for said TR.

2. The physical authentication trust factor system of claim 1 further comprising a user uses said user device to access said system and query for a report of said RVT by entering any of said UETI or said FUI.

3. The physical authentication trust factor system of claim 2 wherein said ATE's and said HTE's further comprise a user data entered by said user for inclusion in said comparison step contributing to said determination of said RVT for said TR.

4. The physical authentication trust factor system of claim 1 wherein said UETI further comprises a second unique identifier (SUI) associated with said object, and
after transmission of said ATE's by said transaction input device when no UETI is linked with said SUI, said processor uses said algorithm to link said SUI to said UETI having said FUI associated with said object.

5. The physical authentication trust factor system of claim 4 wherein said SUI further comprises an inductive coupling device.

6. The physical authentication trust factor system of claim 1 wherein said RVT is adjusted according to a plurality of trust valuations, one of said plurality of trust valuations being an increased value for said RVT when a second unique identifier (SUI) is associated with said object and linked to said FUI within said UETI for said object.

7. The physical authentication trust factor system of claim 1
wherein said processor uses said algorithm for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event,
then when there exists an EI that matches at least one of said device ID, said device description, said transaction ID, said FUI, said date/time stamp, said type of transaction, said location data, said UETI, and/or said transaction event, and
then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT.

8. The physical authentication trust factor system of claim 7 wherein adjustment of said RVT is according to a plurality of trust valuations, one of said plurality of trust valuations being an increased value for said RVT when any of said device ID, said device description, said transaction ID, said FUI, said date/time stamp, said type of transaction, said location data, said UETI, and said transaction event include a second unique identifier (SUI) associated with said object and linked to said FUI within said UETI for said object.

9. The physical authentication trust factor system of claim 4 wherein said transaction input device comprises a cryptographic encoding sequence prior to a reading and/or viewing by a user of said SUI.

10. The physical authentication trust factor system of claim 1 wherein said database further comprises operational connectivity with a distributed ledger for storing up to all of said plurality of EI's, and said plurality of HTE's.

11. The physical authentication trust factor system of claim 1 wherein said database further comprises operational connectivity with a blockchain record for storing up to all of said plurality of EI's, and said plurality of HTE's.

12. The physical authentication trust factor system of claim 1 wherein said database further comprises operational connectivity with a hashgraph record for storing up to all of said plurality of EI's, and said plurality of HTE's.

13. The physical authentication trust factor system of claim 4 wherein said FUI and said SUI are a-fixed connectively to said object in the form of a device having a physical media having storage for storing any combination of elements from said database.

14. The physical authentication trust factor system of claim 1 comprising a consent cloud in the form of a system that compares a plurality of a change, an update, and/or a request for verification of any of said plurality of EI's, and said plurality of HTE's, and/or said RVT to enable able said change, said update, and/or said request.

15. A method of providing a representative value of trust (RVT) for an object comprising
reading a at least one transaction record (TR) having at least one unique electronic tracking identifiers (UETI) each comprising
a first unique identifier (FUI) linked to said object, said FUI having a plurality of FUI data elements said plurality of FUI data elements comprising an automatically unique identifier, and a first physical attribute of said object,
reading a plurality of evaluation indices (EI's), said plurality of EI's comprising any of a weighting criteria, a pattern, a range, and/or a value for at least one of a device ID, a device description, a transaction ID, a date/time stamp, a type of transaction, a location data, said UETI, said FUI, and/or a transaction event,
reading a plurality of historical transactional events (HTE's) said plurality of HTE's comprising said device ID, said device description, said transaction ID, said FUI, said UETI, said date/time stamp, said type of transaction, and said location data, and
comparing each of said TR's to said plurality of EI's and said plurality of HTE's to determine a RVT for said TR.

16. The method of claim 15 wherein said UETI further comprises
a second unique identifier (SUI) associated with said object, and
when no UETI is linked with said SUI linking said SUI to said FUI associated with said object within said UETI.

17. The method of claim 16 wherein reading said SUI further comprises an inductive coupling device.

18. The method of claim 16 wherein said RVT is adjusted according to a plurality of trust valuations, one of said plurality of trust valuations being an increased value for said RVT when a second unique identifier (SUI) is associated with said object and linked to said FUI within said UETI.

19. The method of claim 16 wherein said RVT is adjusted according to a plurality of trust valuations, one of said plurality of trust valuations being an increased value for said RVT when any of said device ID, said device description, said transaction ID, said FUI, said date/time stamp, said type of transaction, said location data, said UETI, and said transaction event include a second unique identifier (SUI) associated with said object and linked to said FUI within said UETI for said object.

20. The method of claim 15 wherein said ATE's and said HTE's further comprise a user data entered by said user for inclusion in said comparison step contributing to said determination of said RVT for said TR.

21. The method of claim 15 wherein for each said plurality of EI's having any of said weighting criteria, said pattern, said range, and/or said value wherein said weighting criteria, said pattern, said range, and/or said value is missing any of said device ID, said device description, said transaction ID, said FUI, said date/time stamp, said type of transaction, said location data, said UETI, and said transaction event,
when there exists an EI that matches at least one of said device ID, said device description, said transaction ID, said FUI, said date/time stamp, said type of transaction, said location data, said UETI, and/or said transaction event, and
then incorporating said device ID, said device description, said transaction ID, said FUI, said date/time stamp, said type of transaction, said location data, said UETI, and said transaction event for each of said weighting criteria, said pattern, said range, and/or said value that is missing any of said device ID, said device description, said transaction ID, said FUI, said date/time stamp, said type of transaction, said location data, said UETI, and said transaction event to adjust said RVT.

22. The method of claim 15 wherein reading of said TR, EI's, and/or HTE's is reading from a distributed ledger storing up to all of said RVT, TR, EI's, and/or HTE's.

23. The method of claim 15 wherein reading of said TR, EI's, and/or HTE's is reading from a blockchain record storing up to all of said RVT, TR, EI's, and/or HTE's.

24. The method of claim 15 wherein reading of said TR, EI's, and/or HTE's is reading from a hashgraph record storing up to all of said RVT, TR, EI's, and/or HTE's.

25. The method of claim 16 wherein said FUI and said SUI are a-fixed connectively to said object in the form of a device having a physical media having storage.

26. The method of claim 15 comprising a consent cloud in the form of a system that compares a plurality of a change, an update, and/or a request for verification of any of said plurality of EI's, and said plurality of HTE's, said TR, and/or said RVT to enable able said change, said update, and/or said request.
